(19) United States
(12) Patent Application Publication
(10) Pub. No.: US 2008/0239709 A1
(43) Pub. Date: Oct. 2, 2008

(54) Concealed Emergency Lighting Fixture with Full Rotation of Door

(75) Inventors: Radu Cornel Rapeanu, Mont-Royal (CA); Michel Lambert, Laval (CA)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 12/045,804

(22) Filed: Mar. 11, 2008

Related U.S. Application Data
(60) Provisional application No. 60/920,717, filed on Mar. 29, 2007.

(51) Int. Cl. F21S 8/00

(52) U.S. Cl. 362/147

(57) ABSTRACT

An emergency lighting fixture includes a door and light source disposed on the door. The door rotates 360 degrees in one direction. A slip clutch assembly permits manual rotation of the door when obstructed by a motor or to remain in the same position when obstructed during rotation by the motor. A capacitor stores energy to close the door. A pressure locking assembly includes a bearing ball biased into engagement with an alignment hole by a spring in response to the door being rotated near a predetermined position. A conductive clip maintains electrical contact with a conductive portion of a hinge as the door rotates. The conductive clip is connected to a power source, and the light source is connected to the conductive portion of the hinge, thereby providing power to the light source after the door has stopped in a pre-determined position or during rotation of the door. The fixture may be used in non-emergency lighting applications.

### CROSS REFERENCE TO RELATED APPLICATION

This application claims the benefit of U.S. Provisional Application No. 60/920,717, filed Mar. 29, 2007, the disclosure of which is incorporated herein by reference.

### BACKGROUND OF THE INVENTION

1. Field of the Invention

The present invention generally relates to emergency lighting fixtures. In particular, the present invention provides various improvements in a concealed emergency lighting fixture.

2. Description of the Related Art

The majority of the prior art is based on a lamp module or box, which includes lamps for emergency lighting and has one or two doors aligned with a mounting wall or ceiling surface. The conventional solutions differentiate themselves by various methods used to open and close the door(s) and the position of the lamps during the emergency lighting.

For example, the device described in U.S. Pat. Nos. 5,025,349; 5,682,131; and 6,097,279 to Gow open and close the door with a motor. The motor is supplied with a reverse polarity voltage to change the sense of rotation when the door is closed, which creates a flip-flop operation. However, this method requires the presence of an external power source (24 Vdc or the like) to close the door.

U.S. Pat. No. 6,164,788 to Gemmel et al. uses a steel spring to open the door and a motor to close the door and compress the spring. However, this method requires the presence of a second power source (AC line) to close the door.

U.S. Pat. No. 5,851,061 to Hegarty uses a mirror installed on the back of the door to reflect the light from the lamp, which is fixed inside the fixture. A solenoid opens and closes the door. However, the light beams are difficult to orient during installation (indirect lighting) and there is a significant loss of light output due to light absorption from reflection.

U.S. Pat. No. 4,802,065 to Minter uses gravitational force to open the doors. The fixture described in this patent is mounted in a ceiling and two doors drop open to allow the lamps to descend for emergency lighting. The two open doors limit the access of each light beam to about half the floor in the room. However, this fixture requires two linear motors or two solenoids to close the doors. In addition, this fixture is not suitable for installation in walls.

U.S. Pat. No. 6,371,621 to Le Bel describes a complex “pulse proportional servo-motor” to open and close a door, which rotates by only 90 degrees. However, this product is expensive (since it requires a special motor) and the lamps cannot be aimed in all directions within the room.

### SUMMARY OF THE INVENTION

An emergency lighting fixture formed in accordance with one form of the present invention, which incorporates some of the preferred features, includes a light source and a door. The light source is disposed on the door. The door is adapted to rotate a full 360 degrees in the same direction about an axis, thereby enabling the light source to be selectively concealed and exposed by rotation of the door in one direction. The door may also be adapted to rotate 360 degrees in two directions. The fixture may include a slip clutch assembly adapted to permit the door to be manually rotated when obstructed from doing so by a motor and/or to permit the door to remain in the same position in response to being obstructed during rotation by the motor.

The fixture may also include a capacitor that stores electrical energy sufficient to close the door. The fixture may include one or more switches to detect a predetermined rotational position of the door. The switches may be activated by a cam that rotates with the door. The fixture may also include a pressure locking assembly, which includes a bearing ball, spring, and alignment hole. The bearing ball is biased into engagement with the alignment hole by the spring in response to the door being rotated near a predetermined position. The predetermined position may be when the rear surface of the door faces forward and/or rearward.

The fixture may further include a hinge, about which the door is rotated, and a conductive clip. The hinge may include an electrically conductive portion and the conductive clip maintains electrical contact with the conductive portion of the hinge as the door is rotated. The conductive clip is electrically connected to a power source and the light source is electrically connected to the electrically conductive portion of the door, thereby providing power to the light source during rotation of the door. The fixture may include a DC power source, AC power source, low-voltage power source, and/or mains voltage power source. The emergency lighting fixture may also be adapted for use in non-emergency lighting applications.

The emergency lighting fixture may also include a motor adapted to rotate the door about the at least one axis, a first voltage regulator, and a second voltage regulator. The first voltage regulator is operatively coupled to the motor, and the motor is adapted to expose the light source in response to receiving power from the first voltage regulator. The second voltage regulator is operatively coupled to the motor, and the motor is adapted to conceal the light source in response to receiving power from the second voltage regulator. The emergency lighting fixture may also include a diode operatively coupled in series between the first voltage regulator and the motor, a switching device operatively coupled in series between the second voltage regulator and the motor, and a capacitor operatively coupled in parallel across ground and a node between the second voltage regulator and the switching device. The switching device is open when the motor is receiving power from the first voltage regulator, and closed when the motor is not receiving power from the first voltage regulator, thereby providing power from the capacitor to the motor to conceal the light source.

A method of providing light in an emergency in accordance with one form of the present invention, which incorporates some of the preferred features, includes disposing a light source on a door, and rotating the door at least 360 degrees in at least one direction about at least one axis, thereby enabling the light source to be selectively concealed and exposed. The method may include rotating the door at least 360 degrees in at least two directions about the at least one axis, configuring the door to be manually rotated about the at least one axis when obstructed from doing so by a motor, and configuring the door to remain fixed when obstructed and a motor is attempting to rotate the door. The method may further include storing electrical energy sufficient to close the door, and adapting the emergency lighting fixture for use in non-emergency lighting applications. The method may still further include rotating the door about the at least one axis using a motor, wherein the motor is adapted to expose the light source in response to receiving power from a first voltage regulator, and to conceal the light source in response to receiving power from a second voltage regulator.

These and other objects, features, and advantages of this invention will become apparent from the following detailed description of illustrative embodiments thereof, which is to be read in connection with the accompanying drawings.

### BRIEF DESCRIPTION OF THE DRAWINGS

FIGS. 1a-1i are pictorial views of an emergency lighting fixture in accordance with the present invention in various stages as the fixture rotates through a complete 360 degrees.

FIGS. 2a and 2b are side and rear perspective views, respectively, of the emergency lighting fixture.

FIGS. 3a and 3b are side views of the emergency lighting fixture when the fixture is in a closed state and an open state, respectively.

FIG. 4 is a perspective view of a door assembly used in the emergency lighting fixture.

FIG. 5 is a more detailed view of a hinge mechanism used in the emergency lighting fixture.

FIG. 6 is a side perspective view of the emergency lighting fixture in a partially open state.

FIG. 7a is a more detailed view of the hinge mechanism used in the emergency lighting fixture.

FIG. 7b is an exploded view of the hinge mechanism used in the emergency lighting fixture.

FIG. 8a is a block diagram of an electrical circuit used in the emergency lighting fixture.

FIG. 8b is a side view of a hinge cam mechanism with electrical switches used in the emergency lighting fixture.

### DETAILED DESCRIPTION OF THE PREFERRED EMBODIMENTS

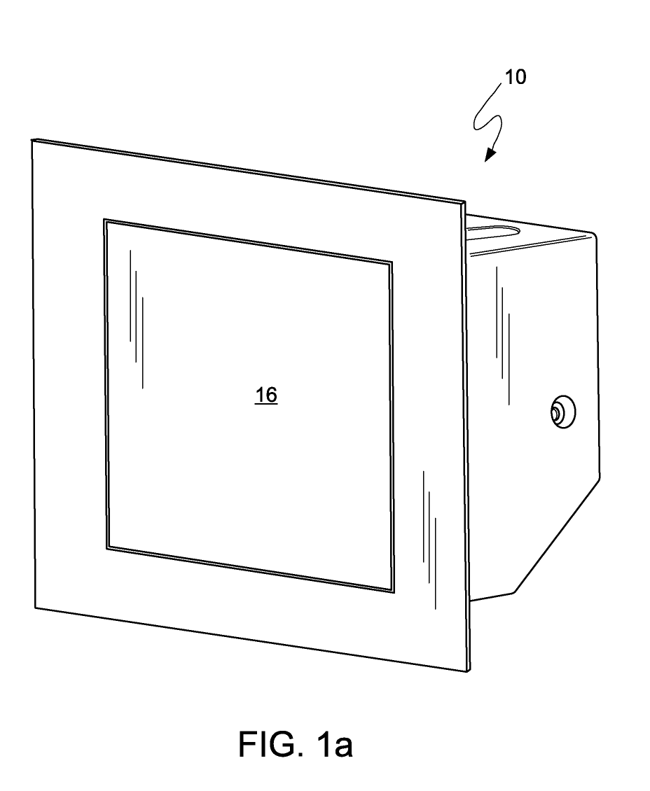

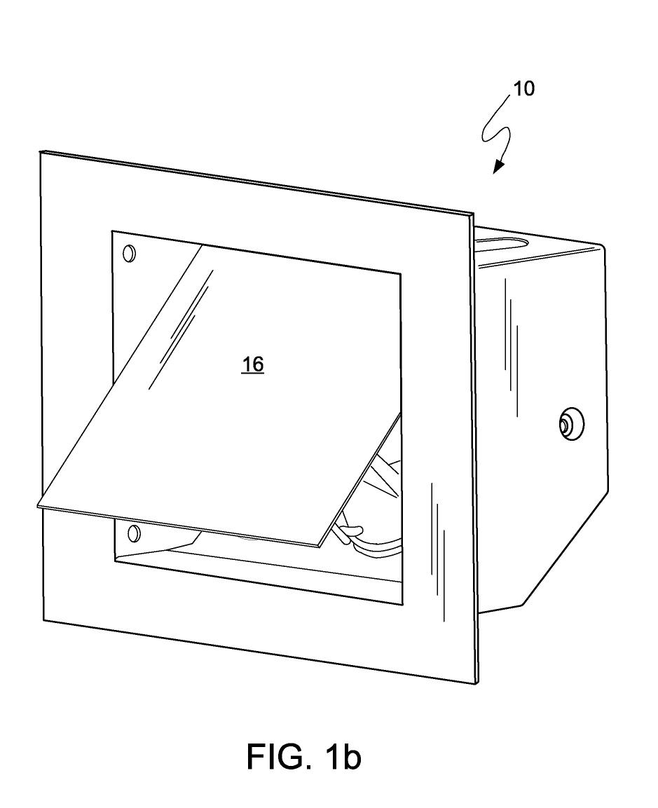

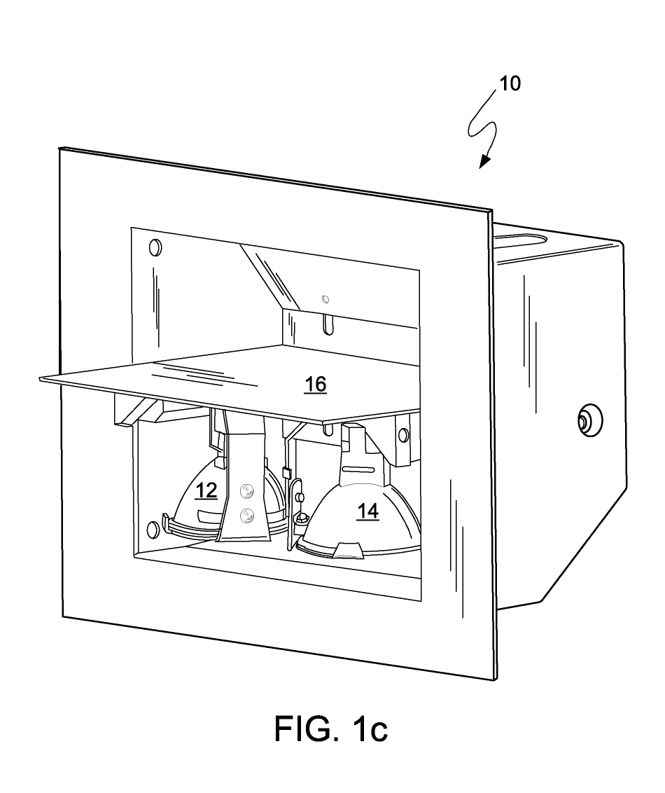

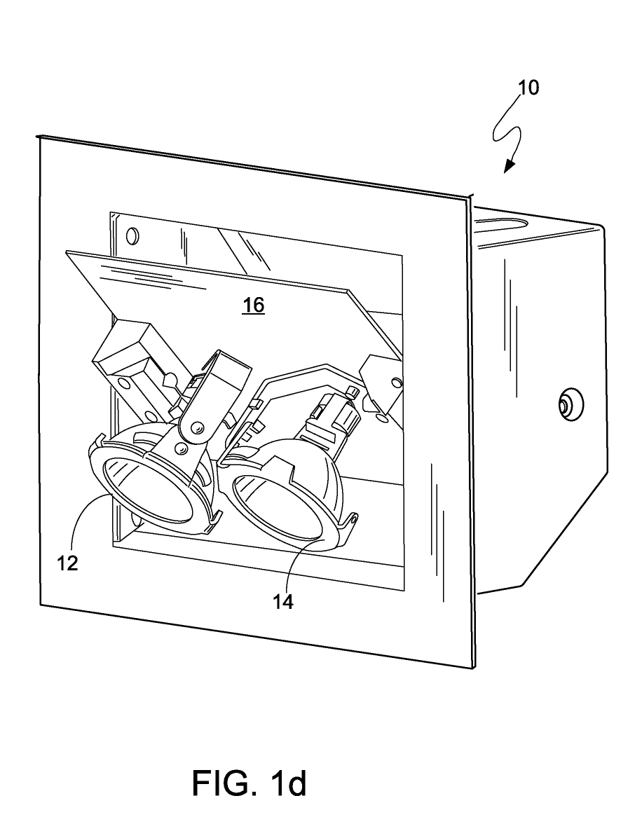

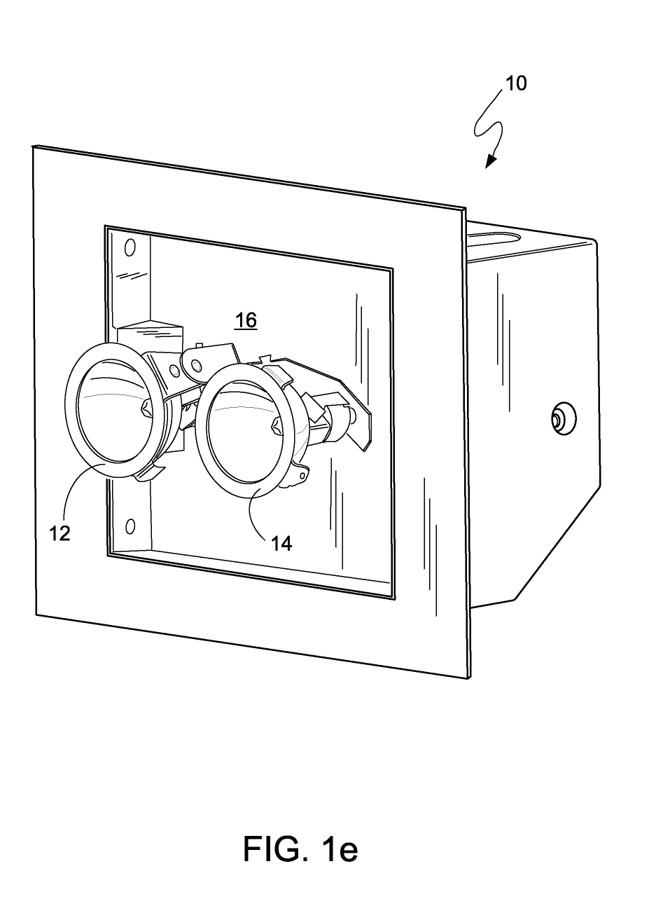

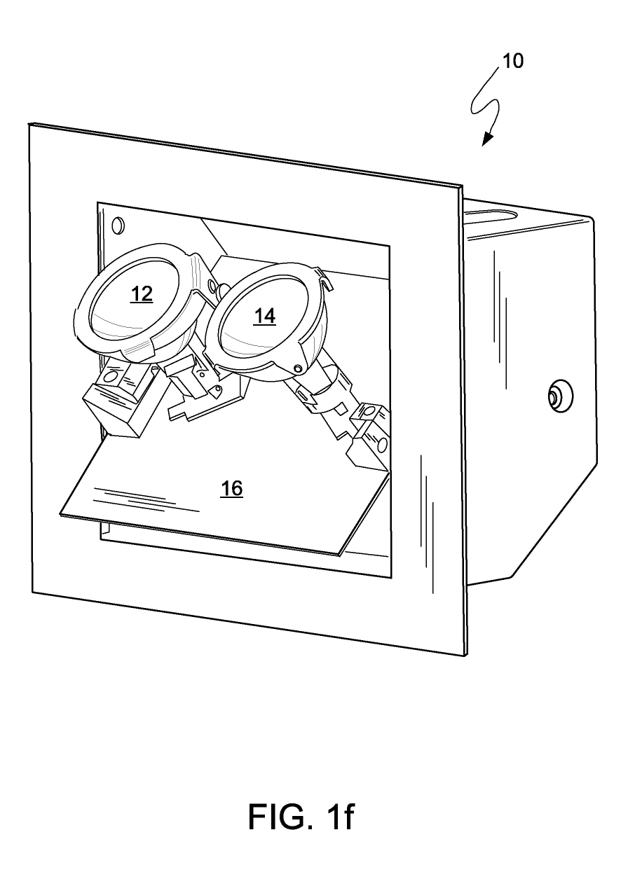

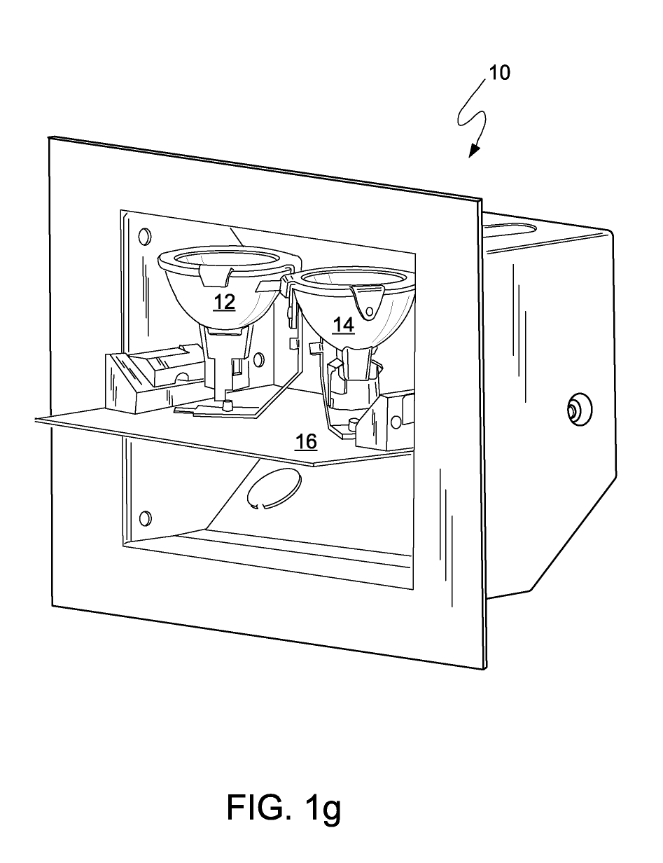

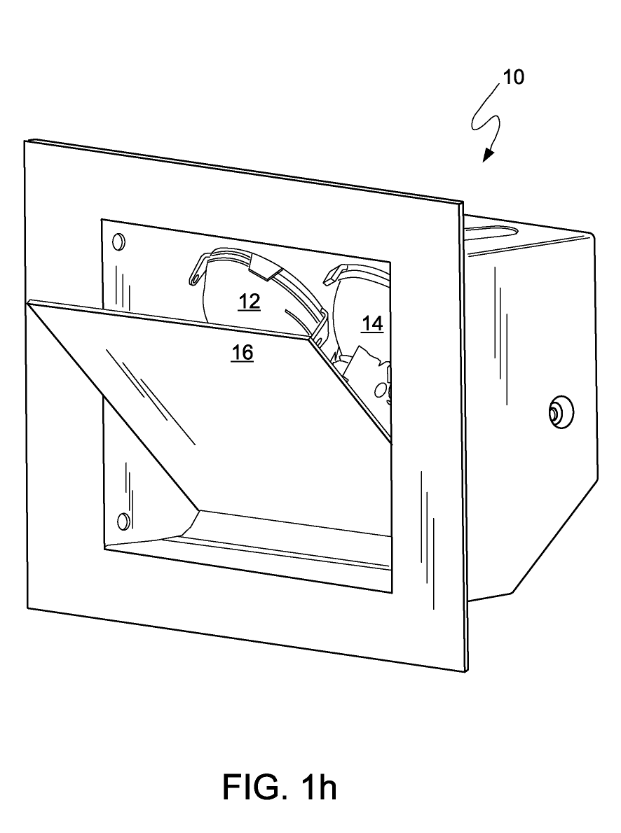

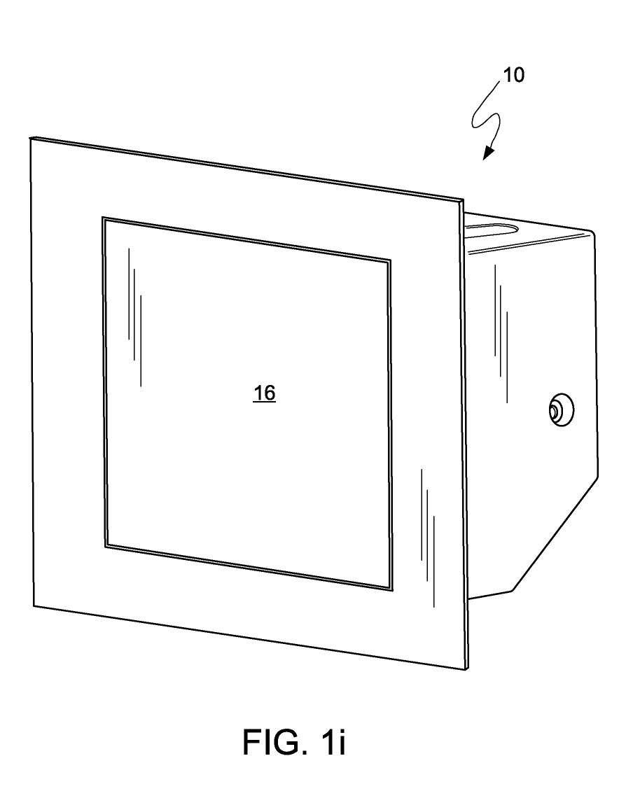

The present invention is directed to an emergency lighting fixture 10 shown in FIGS. 1a-1i, which is designed for concealed installation in ceilings or walls of buildings. A lamp module includes emergency lights 12, 14 shown in FIGS. 1d-1h. The lamp module is preferably recessed in a wall (or ceiling) and it includes a door 16, which is aligned with the surface of the wall. One of the primary features is that the door 16 is installed with two hinges that are able to rotate 360 degrees, which is illustrated in FIGS. 1a-1i.

The lamps or emergency lights 12, 14 are installed on the back of the door 16. During a power failure, a miniature motor preferably turns the door by 180 degrees and exposes the lamps 12, 14, which will illuminate the path of egress. The lamps 12, 14 can be oriented in virtually any direction in space (preferably 360 degrees horizontal and ±90 degrees vertical). At the end of the power outage, the door 16 closes by rotating 180 degrees in the same direction as before, which enables a full 360 degree rotation. The motor and the door 16 preferably always turn in the same direction, which makes the gear design simple and cost-effective in comparison with traditional “flip-flop” mechanisms of door movement.

A second feature of the emergency lighting fixture 10 is a simple slip clutch included in the transmission mechanism. This device allows the rotation of the motor and other gears even when an obstacle blocks the door movement. This feature protects the electrical motor from overcharge and also protects people during accidental mishandling of the fixture. The slip clutch mechanism also allows the user to force-open and force-close the door during installation or maintenance of the equipment. The slip clutch preferably has a simple construction, is built-in the door hinge, and does not require calibration.

A third feature of the emergency lighting fixture 10 is a circuit that uses a capacitor or other energy storing device, such as a battery, to store the electrical energy required to close the door. The circuit charges the capacitor during power-up, as well as before and while the door opens. When the external emergency power supply is disconnected or fails, the lamps 12, 14 preferably turn off and the capacitor supplies the motor with stored electrical energy, which closes the door. The advantages of this invention include energy savings (no power consumption for the motor, clutches, and the like during the emergency period), lower cost, and no need for a second line of power (AC line voltage) to close the door.

Regarding the door and hinges, the invention preferably uses a lamp box with one door 16 mounted with two axial hinges, installed on the central axis of the door as shown in FIGS. 1a-1i. The hinges allow the door 16 to rotate easily for 360 degrees around its central axis, with multiple turns in the same direction. The two emergency lamps 12, 14 are preferably installed on the back of the door 16. When the door 16 is closed, the lamps 12, 14 are concealed in the box. When the door opens (turns 180 degrees), the lamps 12, 14 are completely exposed towards the room and can be aimed in virtually any direction in space.

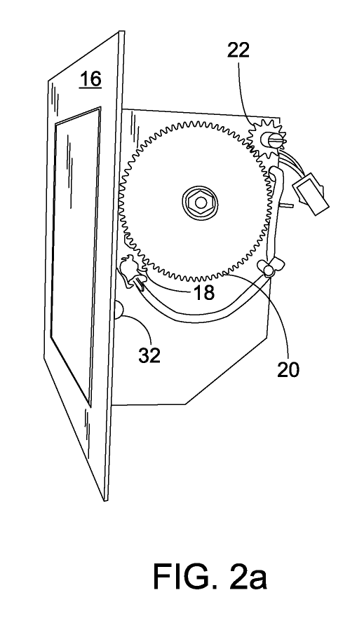

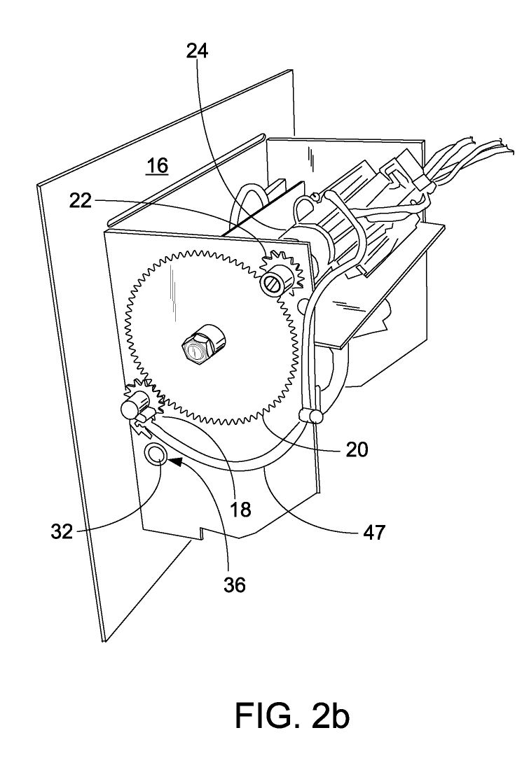

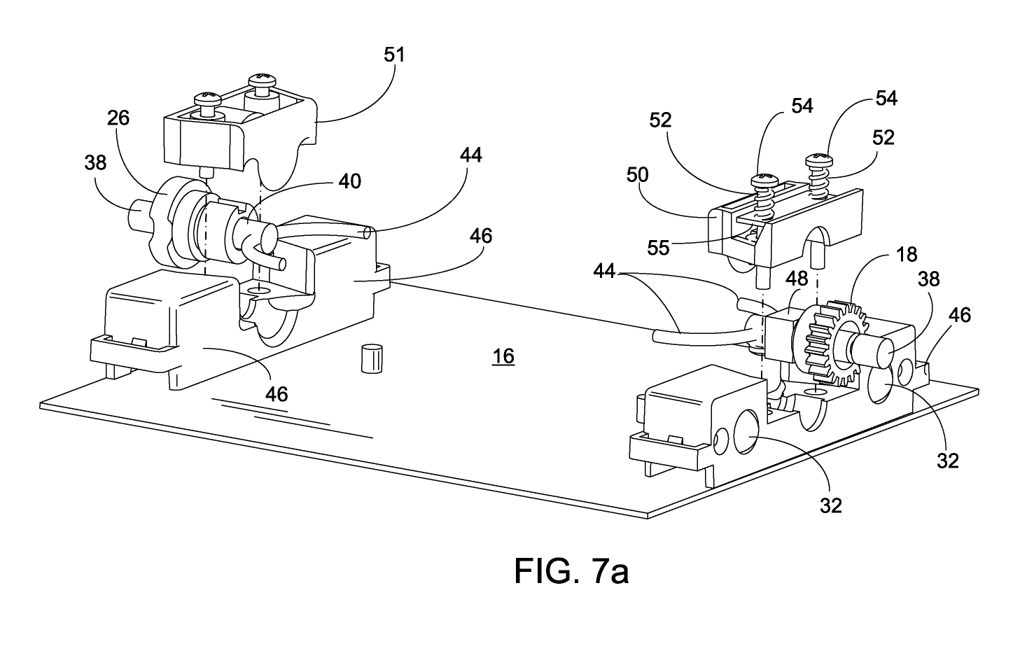

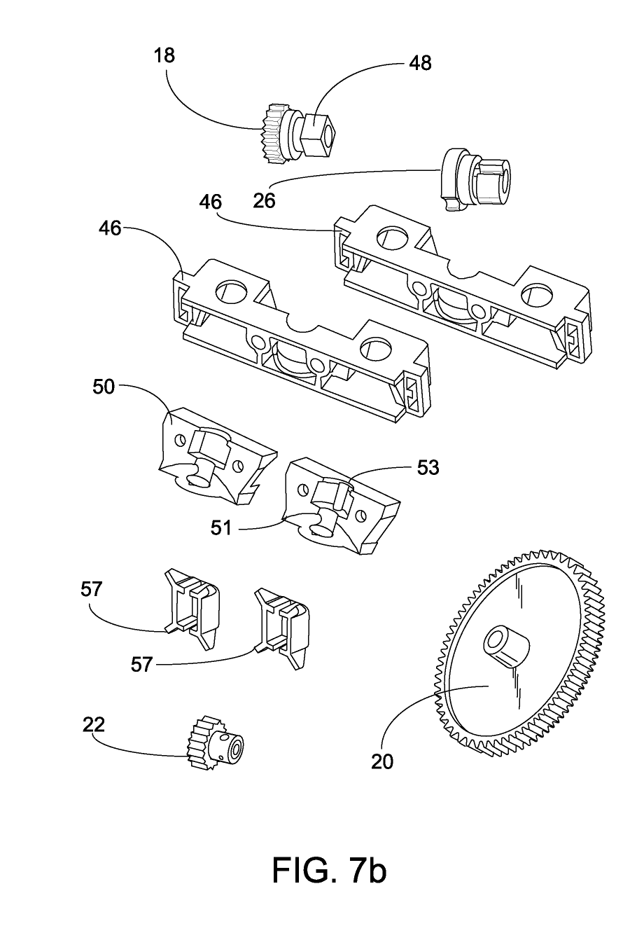

One of the two door hinges preferably has its axle terminated with a spur gear 18 and can slide (rotate) in the hinge housing. The spur gear 18 is further connected through a gear mechanism 20, 22 to a linear motor 24 shown in FIGS. 2a and 2b. The motor 24 preferably opens and closes the door 16 by rotating continuously in the same direction. The second hinge of the door preferably has its axle terminated with a cam 26. This axle is preferably solidly or rigidly connected with the hinge housing. Thus, the cam 26, spur gear 18, and square tube 48 shown in FIGS. 7a and 7b are not attached to the hinges, but are preferably part of the hinge axles. The cam end of the axle is preferably held rigid or locked in its hinge housing 51 by a protrusion 53 extending from the cam end housing 51 that engages with a slot in the cam 26 axle. The spur gear end of the axle can preferably slip or rotate in its hinge end housing 50, which preferably includes an opening to allow the square tube 48 to rotate therein.

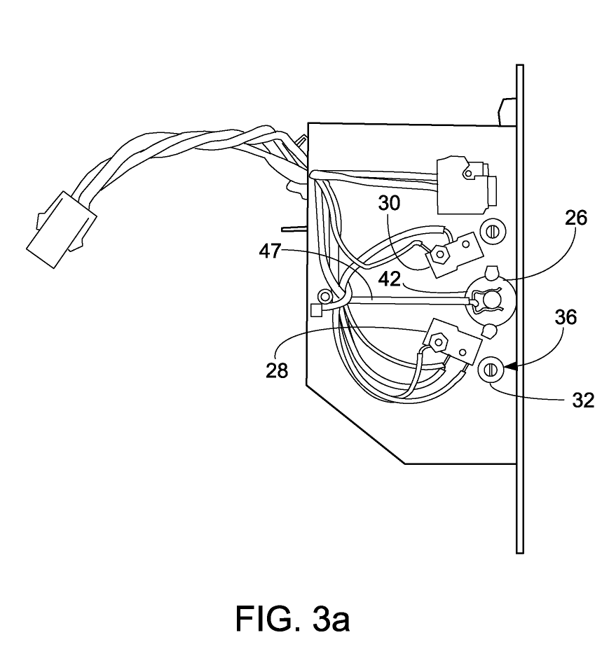

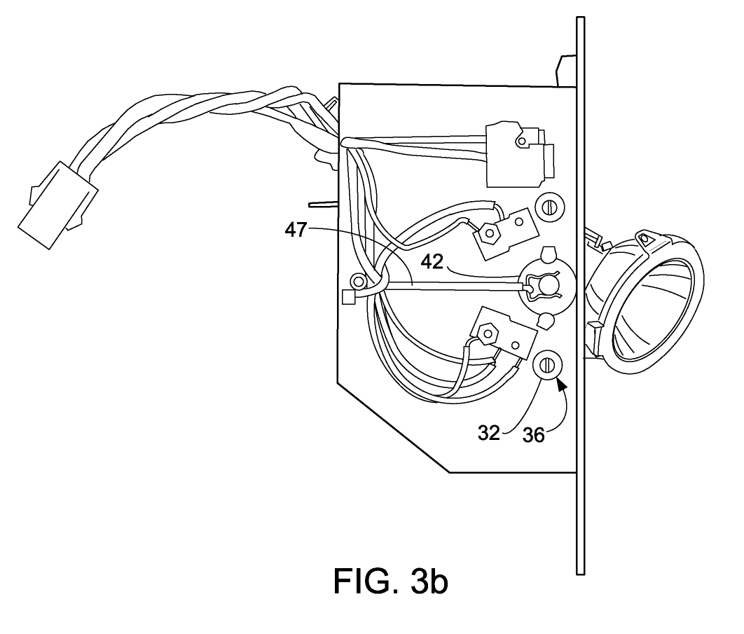

Two electrical switches 28, 30 are positioned along the diameter of the cam, as shown in FIGS. 3a and 3b. The cam 26 preferably activates sequentially each switch 28, 30 when the door 16 is either closed or completely open (180 degree turn). The two switches 28, 30 are preferably connected to an electrical circuit designed to control the motor 24 that, for example, stops the motor 24 when the door 16 is completely open or completely closed.

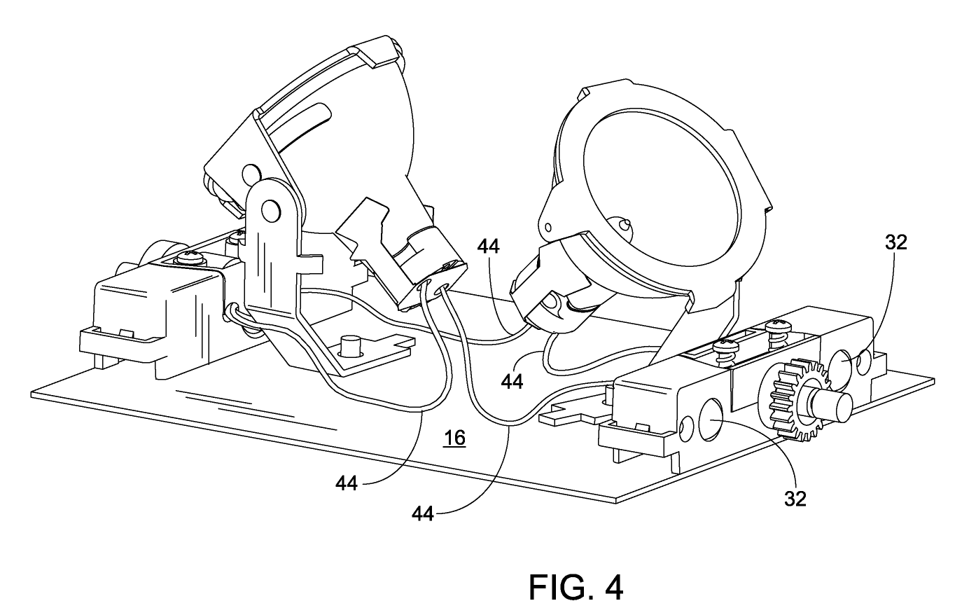

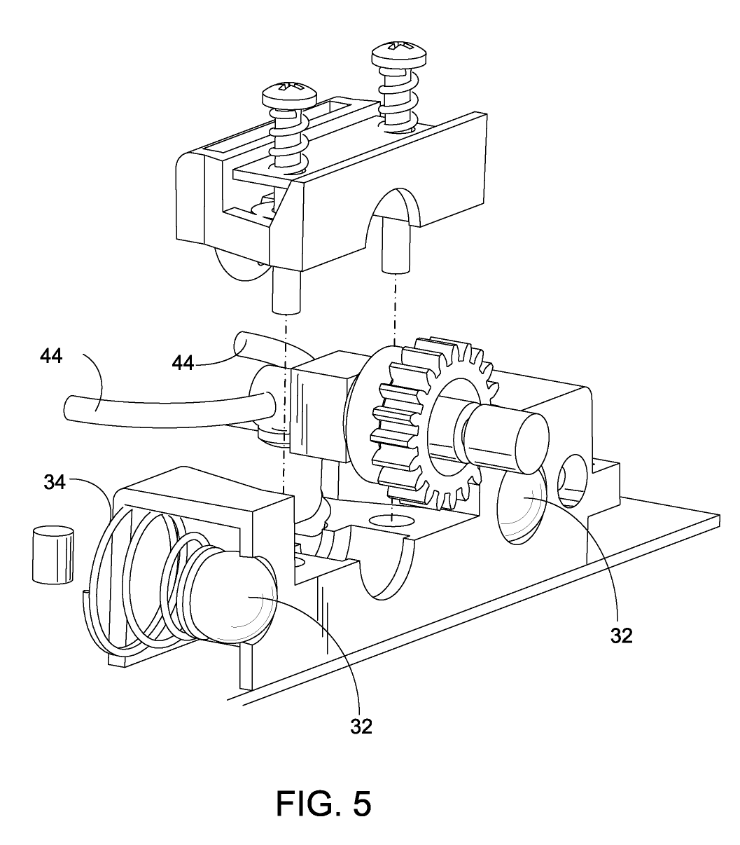

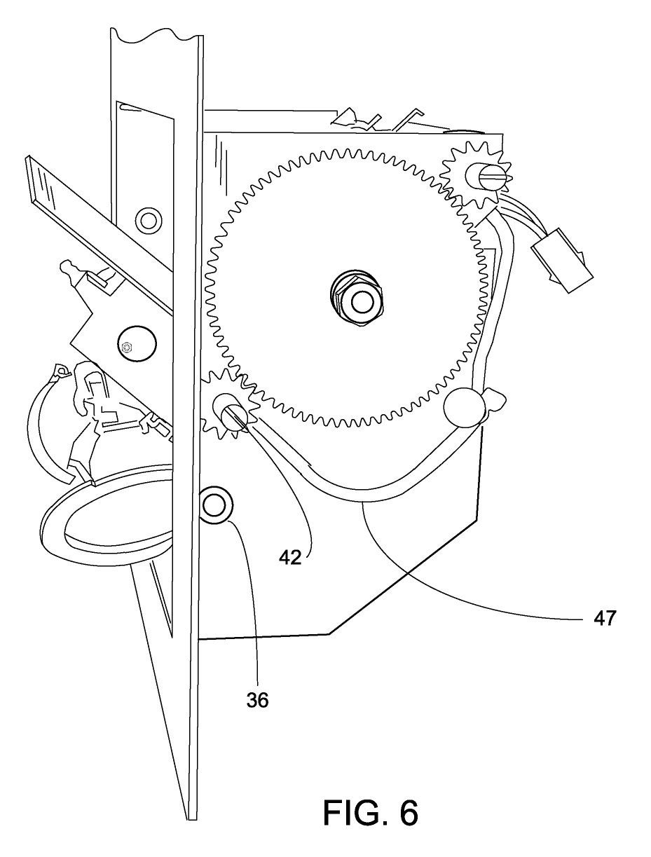

The door 16 is preferably aligned in a closed or open position by a pressure locking mechanism built with bearing balls 32 and steel springs 34 shown in FIGS. 4 and 5. Two bearing balls 32 and springs 34 are preferably installed in the body of each hinge shown in FIG. 5. The lateral walls of the fixture housing preferably include alignment holes 36 that engage with the balls 32 as shown in FIG. 6. When the door is almost closed (or almost completely open) and the motor 24 is turned off, the balls 32 preferably snap in the alignment holes 36, which stops the door inertial movement of the door.

Regarding the sliding electrical connectors, the two hinges are preferably made of an electrically isolating material, such as, but not limited to, a plastic, and include a hole 40 along their longitudinal axis. Each hinge preferably includes a metallic cylinder 38 installed in the hole 40, which functions as an electrical connection between the lamps 12, 14 and the wires 47 installed on the fixture frame shown in FIGS. 2 and 3. On the door side of the hinge, the lamp wires 44 are fixed with screws at one end of each cylinder. At the other end (fixture housing), metal spring clips 42 are snapped onto the metallic cylinder head 38 as shown in FIG. 6. The clips 42 preferably slides during the rotation of the metallic cylinder 38, which maintains the electrical connection necessary to provide power to the lamps 12, 14. The two spring clips 42 are further connected to wires 47, which are fixed on the lamp box to an emergency power source. The two metal cylinders 38 and their sliding clips 42 enable electrical connection of the mobile lamps, which rotate with the door, to the fixed lamp housing and external emergency power source, which is preferably a battery circuit. Even if the metallic cylinder 38 provides electrical connection at all times, in the preferred embodiment, the lamps are only powered when the door is completely open, which is when the cam 26 releases the switch SW1 28. Alternatively, the lamps may be powered at all times.

Regarding the slip clutch mechanism shown in FIGS. 7a and 7b, the connection of the hinge to the spur gear 18 is loose in the gear axis, allowing the spur gear 18 to rotate (slip) independently from the hinge body 46 and the metal cylinder 38. However, to allow a controlled slip torque between these components, the spur gear 18 is preferably terminated with the square tube 48. The upper part of the hinge body or housing 50 preferably includes a metal plate 55 firmly held in contact with the square tube 48 by two steel springs 52 held in place with screws 54. FIG. 7b also shows caps 57, which are preferably made from plastic, that are used to cover and electrically isolate the spring clips 42 at the ends of the metallic cylinders 38. The caps 57 preferably include pin extensions that lock in the metal frame to prevent the cap and wire from rotating when the door and metal cylinders turn.

During normal operation, the pressure exercised by the two springs 52 and the metal plate 55 on the square tube 48 preferably keeps the hinge axle from rotating on the hinge body 46 independently of the motor and allows the torque of the spur gear 18 to engage the door 16 during rotation. However, if the door 16 is blocked while the motor 24 and spur gear 18 are in motion, the torque force of the square tube 48 will apply an upward force to the metal plate 55, which will eventually compress the two springs 52 to disengage the slip clutch mechanism for about a quarter of a turn (90 degrees). If, after this, the door is still locked, the clutch will continue to slip periodically by about a quarter turn, until the motor stops or the door is released. In addition, if the spur mechanism 18 is locked and the motor has stopped, one can force the door 16 open or closed and access the inside of the fixture by forcing the door open, thereby engaging the same slip clutch mechanism.

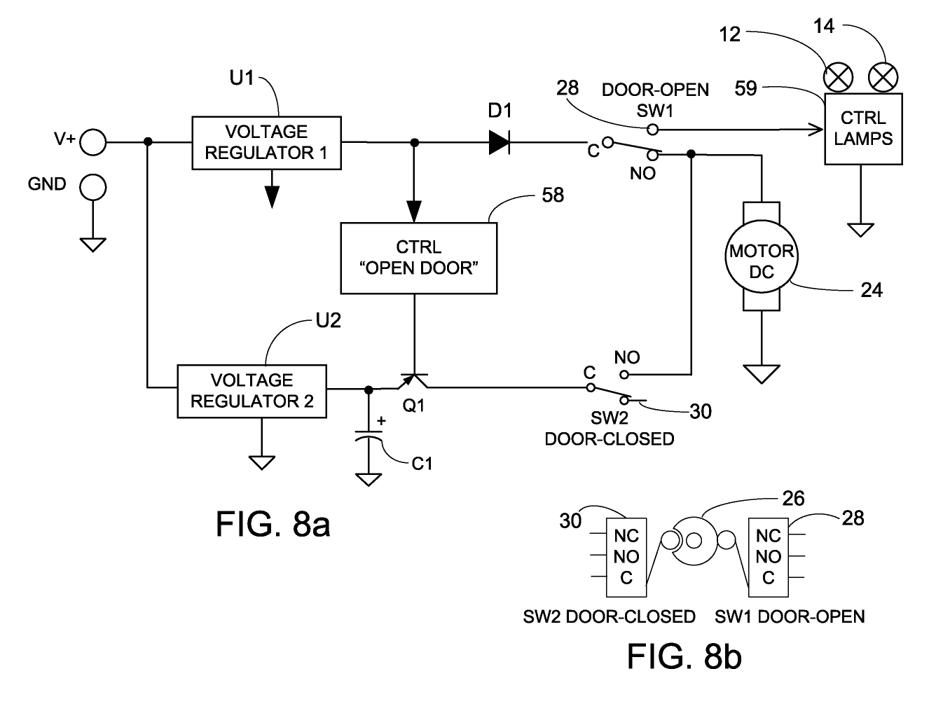

The energy storage circuit 56 shown in FIG. 8a preferably controls the power supply to the motor (start and stop function) in response to activation of the emergency power supply and the position of the two door switches 28, 30. The circuit 56 preferably transfers electrical power to the lamps only while the door is completely open, which prevents accidental overheating of the fixture.

The electrical circuit 56 preferably includes a capacitor C1, which is able to store the energy required by the motor 24 to rotate the door 16 until it is closed.

When the emergency lighting fixture 10 is powered by a voltage V+, a voltage regulator U1 provides current via the diode D1 and switch SW1 to the motor 24, which drives the door to open. Electrical current to the motor is limited in value by the regulator U1 to prevent overheating during abnormal conditions, such as when the motor or gear are restricted from moving. When the door is completely open, the switch SW1 28 preferably changes state, which turns the motor 24 off and supplies current to a control circuit 59 to power the lamps 12, 14. This is the emergency lighting state.

At the same time, after the power supplies the voltage V+, a second voltage regulator U2 preferably charges the capacitor C1. The charging current is preferably limited in value by the regulator U2 in accordance with the electrical specifications of the capacitor C1. In the emergency lighting state the control circuit 58 preferably keeps transistor Q1 off, which isolates capacitor C1 from the motor circuit.

When the emergency power is disconnected, that is V+=0, a close door control circuit 58 preferably turns transistor Q1 on. The capacitor C1 then preferably supplies current through transistor Q1 and switch SW2 30 to the motor 24, which starts rotating the door. When the door is completely closed, the switch SW2 30 preferably disconnects the power supply and the motor 24 stops. The capacitor C1 is preferably fully recharged when the fixture is powered and the door opens.

The advantages of the emergency lighting fixture in accordance with the present invention include:
1. Full orientation in space of the emergency lamps since the door opens by turning 180 degrees.
2. The opening and closing of the door is achieved with only one simple (linear) motor. Thus, there is no need to rely on gravitational force, which would make it impossible for the fixture to be wall-mounted), mirrors, additional springs to open or close the door, and the like.
3. A cost-efficient simple mechanism that is easy to install without the need for torque calibration, since the torque (slip force) of the slip clutch mechanism is controlled by springs, and the motor does not consume power when the door is idle.
4. The electrical circuit does not require external power, such as an AC power line, to close the door.

It is to be noted that a concealed emergency lighting fixture in accordance with the present invention can also be used for general lighting applications. Further, the external power source can supply DC and/or AC current. In addition the external power source may be low-voltage or mains voltage, such as an AC power line. It is also to be noted that the concealed lighting fixture in accordance with the present invention can use less than four (4) bearing balls such as one, two, or three bearing balls for door alignment.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An emergency lighting fixture comprising:
a light source; and
a door, the light source being disposed on the door, the door being adapted to rotate at least 360 degrees in at least one direction about at least one axis, thereby enabling the light source to be selectively concealed and exposed.

2. The emergency lighting fixture defined by claim 1, wherein the door is adapted to rotate at least 360 degrees in at least two directions about the at least one axis.

3. The emergency lighting fixture defined by claim 1, further comprising a slip clutch assembly configured to enable the door to be manually rotated about the at least one axis when obstructed from doing so by a motor.

4. The emergency lighting fixture defined by claim 1, further comprising a slip clutch assembly configured to enable the door to remain fixed when obstructed and a motor is attempting to rotate the door.

5. The emergency lighting fixture defined by claim 1, further comprising a capacitor adapted to store electrical energy sufficient to close the door.

6. The emergency lighting fixture defined by claim 1, further comprising a switch adapted to detect a rotational position of the door.

7. The emergency lighting fixture defined by claim 6, wherein the switch is activated by a cam rotating with the door.

8. The emergency lighting fixture defined by claim 1, further comprising a pressure locking assembly comprising a bearing ball, spring, and alignment hole, the bearing ball being biased into engagement with the alignment hole by the spring in response to the door being rotated to a predetermined position.

9. The emergency lighting fixture defined by claim 1, further comprising:
a hinge about which the door is rotated, the hinge comprising an electrically conductive portion; and
a conductive clip configured to maintain electrical contact with the conductive portion of the hinge as the door is rotated, the conductive clip being electrically connected to a power source, the light source being electrically connected to the electrically conductive portion of the door, thereby providing power to the light source at least one of after the door has stopped in a predetermined position and during rotation of the door.

10. The emergency lighting fixture defined by claim 1, further comprising a power source configured to provide power to the light source, the power source being at least one of a DC power source, AC power source, low-voltage power source, and mains voltage power source.

11. The emergency lighting fixture defined by claim 1, wherein the emergency lighting fixture is adapted for use in non-emergency lighting applications.

12. The emergency lighting fixture defined by claim 1, further comprising:
a motor adapted to rotate the door about the at least one axis;
a first voltage regulator operatively coupled to the motor, the motor being adapted to expose the light source in response to receiving power from the first voltage regulator; and
a second voltage regulator operatively coupled to the motor, the motor being adapted to conceal the light source in response to receiving power from the second voltage regulator.

13. The emergency lighting fixture defined by claim 12, further comprising:
a diode operatively coupled in series between the first voltage regulator and the motor;
a switching device operatively coupled in series between the second voltage regulator and the motor; and
a capacitor operatively coupled in parallel across ground and a node between the second voltage regulator and the switching device, the switching device being open when the motor is receiving power from the first voltage regulator, the switching device being closed when the motor is not receiving power from the first voltage regulator, thereby providing power from the capacitor to the motor to conceal the light source.

14. A method of providing light in an emergency comprising:
disposing a light source on a door; and
rotating the door at least 360 degrees in at least one direction about at least one axis, thereby enabling the light source to be selectively concealed and exposed.

15. The method of providing light in an emergency defined by claim 14, further comprising rotating the door at least 360 degrees in at least two directions about the at least one axis.

16. The method of providing light in an emergency defined by claim 14, further comprising configuring the door to be manually rotated about the at least one axis when obstructed from doing so by a motor.

17. The method of providing light in an emergency defined by claim 14, further comprising configuring the door to remain fixed when obstructed and a motor is attempting to rotate the door.

18. The method of providing light in an emergency defined by claim 14, further comprising storing electrical energy sufficient to close the door.

19. The method of providing light in an emergency defined by claim 14, further comprising adapting the emergency lighting fixture for use in non-emergency lighting applications.

20. The method of providing light in an emergency defined by claim 14, further comprising rotating the door about the at least one axis using a motor, the motor being adapted to expose the light source in response to receiving power from a first voltage regulator, the motor being adapted to conceal the light source in response to receiving power from a second voltage regulator.
